(19) United States
(12) Patent Application Publication
(10) Pub. No.: US 2009/0300640 A1
(43) Pub. Date: Dec. 3, 2009

(54) ALLOCATION IDENTIFICATION APPARATUS OF I/O PORTS, METHOD FOR IDENTIFYING ALLOCATION THEREOF AND INFORMATION PROCESSOR

(75) Inventor: Tetsuo AKITOMI, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/392,562

(22) Filed: Feb. 25, 2009

(30) Foreign Application Priority Data
Jun. 3, 2008 (JP) 2008-146147

(51) Int. Cl. G06F 9/50; G06F 13/00

(52) U.S. Cl. 718/104; 710/100

(57) ABSTRACT

An allocation identification apparatus of input/output ports of an information processor (PC) operated as two or more virtual information processors, includes input/output ports (I/O ports) allocated to the virtual information processors, an identification information generating part (a hyper visor) that identifies the virtual information processors to which the input/output ports of the information processor are assigned and that generates identification information thereof, and a display part that displays the identification information generated by the identification information generating part.

### CROSS-REFERENCE TO RELATED APPLICATIONS

This application is based upon and claims the benefit of priority of the prior Japanese Patent Application No. 2008-146147, filed on Jun. 3, 2008, the entire contents of which are incorporated herein by reference.

### FIELD

The present embodiments relate to allocation of input/output ports in an information processor that composes a virtualized system operated as two or more virtual information processors and to identification thereof. More particularly, the present embodiments relate to an allocation identification apparatus of input/output ports if a plurality of input/output ports in an information processor such as a personal computer (PC) are allocated to different virtual information processors, a method for identifying allocation thereof and an information processor.

### BACKGROUND

Conventionally, the virtualized system is known that one computer is logically divided as if it were a plurality of computers, and different OSs (Operating System) and/or pieces of different application software are operated by each of logically divided computers. In a plurality of input/output ports equipped for this virtualized system, there exist input/output ports allocated for a single OS that is set in advance and input/output ports allocated in a state where operation can be performed from a plurality of OSs.

Concerning such functions and display thereof, Japanese Laid-open Patent Publication No. 09-223099 (paragraph Nos. 0004 and 0009) discloses that, a plurality of processors operating independently and a switch circuit such as an input/output switch circuit are provided in a casing of a computer, and a selected state of a switcher is displayed by an LED. Japanese Laid-open Patent Publication No. 01-292433 (an example) discloses a device that can select a plurality of basic input/output programs, wherein a booting mode is displayed by an LED.

Even if OS and/or pieces of application software are allocated for input/output ports, an operator cannot determine which input/output port an input/output apparatus may be connected to unless an allocated status of an OS during use is confirmed in advance.

As depicted in FIG. 18, concerning a plurality of input/output (I/O) ports 160 disposed in a PC 2, if not virtualized, toward one of the I/O ports 160 where an external device that the PC 2 desiring an access is connected, an I/O port address and data allocated for the port are transmitted and received. Thereby, exchange with the external device can be performed. That is, if an address 100h is allocated for an I/O port (I) 161 and an address 200h is allocated for an I/O port (II) 162, for example, for accessing an external device that is connected to the I/O port 161, accessing data and the address of the I/O port are transmitted.

In this case, if there exist ports that are allocated to permit an operation on a specific OS set in advance and ports that are allocated to permit operations from a plurality of OSs together in a plurality of the I/O ports 160 provided for the PC 2, as depicted in FIG. 19, it is not displayed which OS each port is allocated for to permit operation at actual connection connector parts in the I/O ports 160. Thereby, a user of the PC 2 has some trouble of confirming allocation permission of ports concerning an OS that the user uses from setting information, etc. If connection to an external device, etc. or cancelling thereof is performed without this confirmation, the inconvenience occurs such that connection to an external device during use is cancelled or an external device does not function even if being connected.

Concerning such requests and problems, there is no disclosure or suggestion thereof in any of Japanese Laid-open Patent Publication Nos. 09-223099 and 01-292433, and no disclosure or suggestion about structure, etc. for solving them is presented.

### SUMMARY

According to an aspect of an embodiment of the invention, there is provided an allocation identification apparatus of input/output ports of an information processor that is operated as two or more virtual information processors, the allocation identification apparatus including input/output ports that are allocated to the virtual information processors; an identification information generating part that identifies the virtual information processors to which the input/output ports of the information processor are allocated, and that generates identification information thereof; and a display part that displays the identification information generated by the identification information generating part. According to such structure, an OS controlling each port is clarified, and an accident such that an external device during use is taken off by mistake can be prevented. Thus, convenience can be improved.

According to an aspect of an embodiment of the invention, there is provided an allocation identification method of input/output ports of an information processor that is operated as two or more virtual information processors, the method including allocating input/output ports to the virtual information processors; identifying the virtual information processors to which the input/output ports of the information processor are allocated, and generating identification information thereof; and displaying the generated identification information.

According to an aspect of an embodiment of the invention, there is provided an information processor that is operated as two or more virtual information processors, including a plurality of input/output ports; an allocation part that allocates the input/output ports to the virtual information processors; an identification information generating part that identifies the virtual information processors to which the input/output ports of the information processor are allocated, and that generates identification information thereof; and a display part that displays the identification information generated by the identification information generating part.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Other features and advantages of the present invention are more clearly understood by referring to the attached drawings and each of the embodiments.

### BRIEF DESCRIPTION OF DRAWINGS

FIG. 1 is a block diagram depicting structure of a virtualized PC according to a first embodiment;

FIG. 2 depicts logical blocks of a virtualized PC;

FIG. 3 is a flowchart depicting a booting process of a virtualized PC;

FIG. 4 is a flowchart depicting an internal process of a hyper visor;

FIG. 5 depicts structure of an appearance of a PC according to a second embodiment;

FIG. 6 depicts one example of USB ports having displays;

FIG. 7 depicts one example of USB ports having displays;

FIG. 8 is a flowchart depicting a booting process of a virtualized information processor according to a third embodiment;

FIG. 9 is a flowchart depicting a table making process by a hyper visor;

FIG. 10 is a flowchart depicting an allocation process of I/O ports;

FIG. 11 is a flowchart depicting an allocation displaying process of I/O ports;

FIG. 12 depicts one example of I/O port allocation definition information;

FIGS. 13A and 13B depict one example of allocation tables;

FIG. 14 depicts one example of a display screen of an allocated state;

FIG. 15 depicts structure of an I/O port circuit according to a fourth embodiment;

FIG. 16 depicts a structural example of disposing PCs where I/O ports are shared by virtualization;

FIG. 17 depicts a conventional example of structure of disposing PCs in an office, etc;

FIG. 18 depicts a conventional example of I/O port circuits in a PC; and

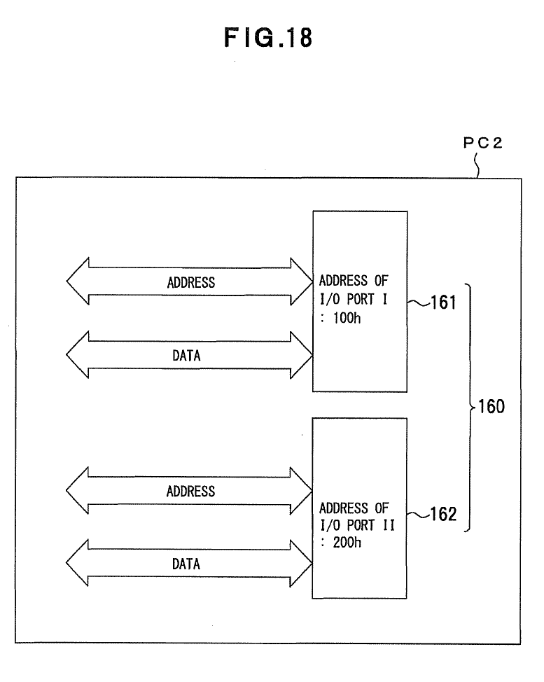

FIG. 19 depicts conventional input/output ports.

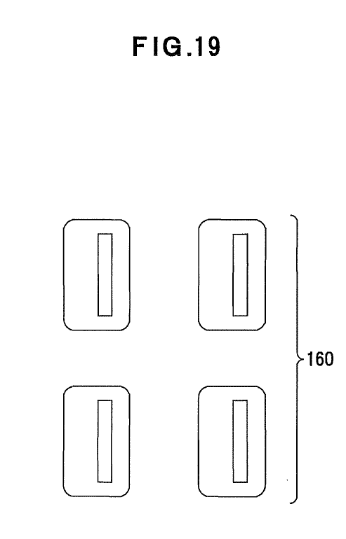

### DESCRIPTION OF EMBODIMENTS

An identification apparatus, an identification method and an information processor of embodiments of the present invention relate to a virtualized information processor, and are a virtualized system in which two or more virtualized information processors are composed of a single or a plurality of information processors. In such virtualized system, two or more virtualized information processors are booted simultaneously. These virtualized information processors arise from execution of a plurality of the same or different OSs in a single or a plurality of information processors. In this case, a plurality of input/output ports in an information processor are allocated for each of virtual information processors. Then, it is identified which virtual information processor input/output ports are allocated for, and identification information thereof is generated. Displaying this identification information clarifies a relationship between input/output ports and virtual information processors, and thereby, an operator can recognize the relationship from display thereof. Therefore, a virtualized system with great convenience results being built.

### First Embodiment

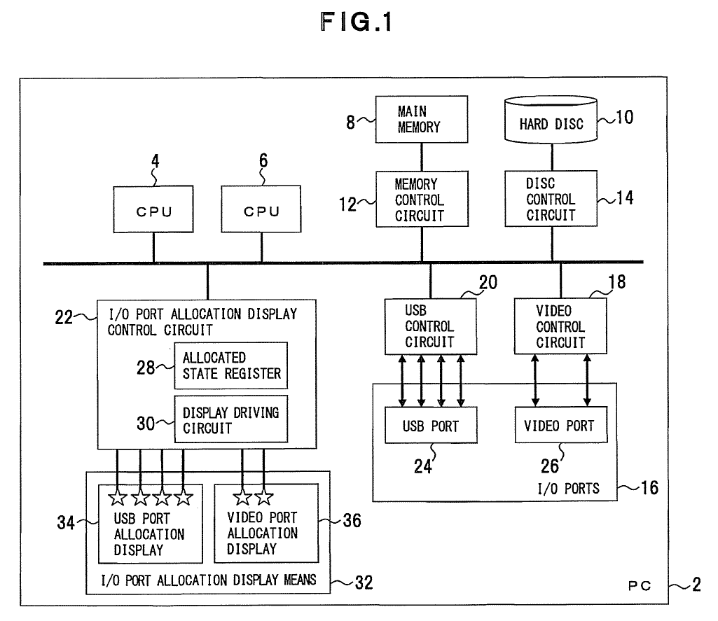

A first embodiment of the present invention will be described with referring to FIG. 1. FIG. 1 is a block diagram depicting structure of a virtualized PC. Structure depicted in FIG. 1 is one example, and the structure is not limited to FIG. 1.

In this embodiment, a personal computer (PC) 2 is one example of an information processor that composes a virtualized system booting a plurality of OSs, etc. simultaneously by virtualization. An inside thereof is composed of a CPUs (Central processing Units) 4 and 6, a main memory 8, a hard disc 10, a memory control circuit 12, a disc control circuit 14, input/output (I/O) ports 16, a video control circuit 18, a USB (Universal Serial Bus) control circuit 20 and an I/O port allocation display control circuit 22, etc.

The CPUs 4 and 6 are control means (part) for processing a hyper visor, an OS and an application program stored in the hard disc 10. In a virtualized system, for example, the CPUs 4 and 6 perform a calculation process for controlling allocation of a plurality of input/output ports (the I/O ports 16) connected to an external device for each OS functioning as a plurality of virtual information processors in a process by a hyper visor program described below.

In the PC 2 depicted in FIG. 1, structure of providing two CPUs 4 and 6 is given. The number of CPUs may be one or more than two irrelevantly to the number of virtual information processors functioning in a virtualized system.

The main memory 8 is one of storing means (part). The main memory 8 is used as a working area for an OS and an application, etc. The main memory 8 is, for example, composed of a RAM (Random Access Memory), etc. Exchange of data with the CPUs 4 and 6, etc. is, for example, controlled by the memory control circuit 12 that is structured in a chipset in the PC 2.

The hard disc 10 is one of storing means (part). The hard disc 10 stores a hyper visor program that is an identification information generating means (part) for identifying an OS and a plurality of virtual information processors to generate identification information thereof and configures an apparatus for identifying allocation of input/output ports, various application programs, identification information of virtual information processors, allocation definition information of I/O ports described below, a BIOS (Basic Input/Output System) that controls peripheral devices connected to the PC 2 and so on. Reading out data and a program from the hard disc 10 is, for example, controlled by the disc control circuit 14 that is structured in the PC 2.

The I/O ports 16 are an interface unit connecting the PC 2 with an external device, etc. and inputting and outputting data, etc. For example, in the I/O ports 16, constructed are a USB port 24 that connects with an external device by using a cable of a USB standard and a video port 26 that connects the PC 2 with an image display device such as a monitor. These USB port 24 and video port 26 are controlled respectively by the USB control circuit 20 and the video control circuit 18 based on identification information of allocation of a virtual information processors by a hyper visor.

The I/O port allocation display control circuit 22 is a display control means (part) for displaying allocation for each OS in virtual information processors so that a user can identify allocation therefor with regard to the I/O ports 16. Inside the I/O port allocation display control circuit 22, included are an allocated state register 28 that stores identification information of allocation of virtual information processors by a hyper visor and a display driving circuit 30 that instructs to an I/O port allocation display means (part) 32 to perform display.

Outside a casing of the PC 2, for example, a USB port allocation display 34 and a video port allocation display 36 are provided as the I/O port allocation display means 32. These USB port allocation display 34 and video port allocation display 36 are, for example, composed of an LED (Light Emitting Diode), and display information for identifying which OS each I/O port is allocated for. This I/O port allocation display means 32 composes an identification apparatus of allocation of input/output (I/O) ports along with the above hyper visor and the I/O port allocation display control circuit 22.

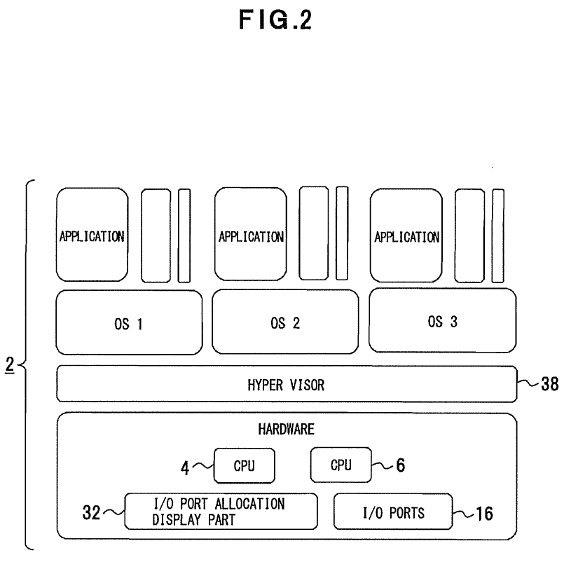

Structure of a virtualized information processor will be described with referring to FIG. 2. FIG. 2 depicts logical blocks of a virtualized PC. In FIG. 2, the same components as those in FIG. 1 are denoted by the same reference numerals, and description thereof is omitted. Structure depicted in FIG. 2 is one example, and the structure is not limited to FIG. 2.

In the virtualized PC 2, for example, a plurality of different OSs, an OS 1, an OS 2 and an OS 3 are independently booted as virtual information processors. In each OS, one or a plurality of applications are booted. Hardware is allocated for each OS and is connected thereto. Between each of these OS 1, OS 2 and OS 3, and a hardware side, constructed is a hyper visor 38 that is an intermediate layer booting a plurality of OSs on a single piece of hardware and processing a memory and a function such as storage management, and is a generating means (part) for identification information concerning a virtual information processor to which the input/output ports (I/O ports 16) are allocated as the above.

In this case, at an I/O ports 16 side, connection with an external device is permitted in response to an access from a□ allocated OS, and connection therewith is rejected in response to an access from an unallocated OS. For example, if an I/O address sent from an OS to the I/O ports 16 side does not correspond with an I/O address set in the USB port 24 or the video port 26, the USB control circuit 20 or the video control circuit 18 controls the USB port 24 or the video port 26, for example, into a state where the USB port 24 or the video port 26 has no resource to function so that the OS cannot access to the USB port 24 or the video port 26.

According to such structure, the hyper visor 38 controls allocation of the I/O ports 16 for each of the booting OS 1, OS 2 and OS 3, and generates identification information of I/O ports concerning allocation of the I/O ports 16. In response to identification information thereof, the hyper visor 38 controls display over the I/O port allocation display means 32.

In the PC 2 depicted in FIG. 2, the state is given that three OSs are booted by virtualization. The number of booted OSs is not limited thereto.

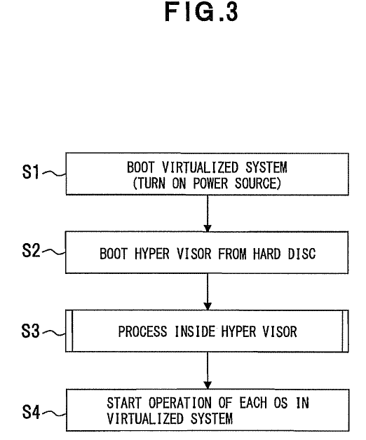

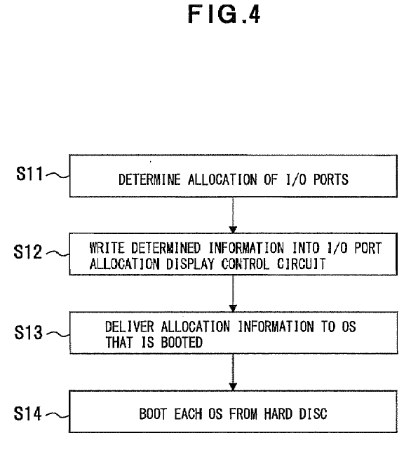

A booting process of a virtualized information processor will be described with referring to FIGS. 3 and 4. FIG. 3 is a flowchart of a booting process of a virtualized PC, and FIG. 4 is a flowchart depicting a subroutine about an internal process of a hyper visor.

Allocation of the I/O ports 16 of the virtualized PC 2 and display control thereof are performed by the hyper visor 38 like the above.

In the PC 2, when a power source for booting a virtualized system is turned on (step S1), the hyper visor 38 stored in the hard disc 10 is booted up (step S2).

In a process inside the hyper visor 38, processes concerning allocation of the I/O ports 16 and display control thereof are executed (step S3), and operation of each OS is started in a virtualized system (step S4).

A subroutine in FIG. 4 is referred about the process inside the hyper visor 38 in the booting process of the PC 2 (step S3). The allocation is determined which OS the I/O ports 16 are usable for (step S11). Determined allocation control information is written into an I/O port allocation display control circuit 22 side (step S12), and identification information of an allocated OS is displayed by the I/O port allocation display means 32.

Allocation information of the I/O ports 16 is delivered to an OS that is going to be booted (step S13), and each OS is read out from the hard disc 10 to be booted up (step S14).

According to such structure, when an external device is connected by using a plurality of input/output ports (the I/O ports 16) provided in a virtualized system, it can be easily determined which port each OS during boot can be connected to.

### Second Embodiment

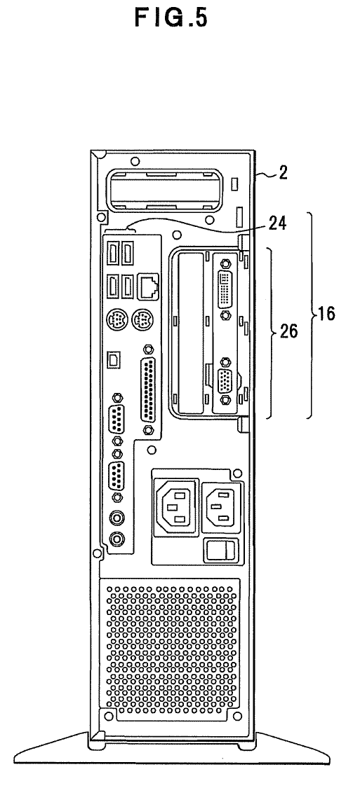

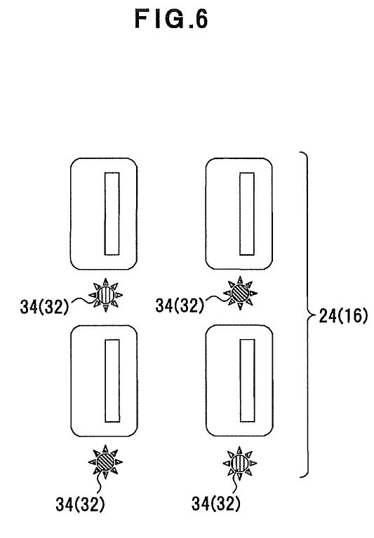

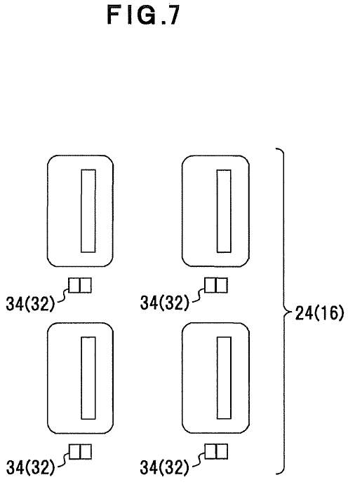

A second embodiment will be described with referring to FIGS. 5, 6 and 7. FIG. 5 depicts structure of an appearance of a PC and FIGS. 6 and 7 depict one example of I/O ports having display means (part). In FIGS. 5, 6 and 7, the same components as those in FIG. 1 or 2 are denoted by the same reference numerals. Structure in FIGS. 5, 6 and 7 is one example, and the structure is not limited to FIGS. 5, 6 and 7.

In this embodiment, given is a concrete example of I/O ports 16 that are input/output means (part) of a PC 2, one example of an information processor constructing a virtualized system.

As depicted in FIG. 5, for example, connectors under various standards are structured as the I/O ports 16 at a rear side of the PC 2. The connectors include the above described USB ports 24 and video ports 26. When the PC 2 functions as a plurality of virtual information processors by virtualization, the I/O ports 16 usable for each OS of virtual information processors are allocated.

In such structure, for example, as depicted in FIG. 6, USB port allocation displays 34 using LEDs, etc. are disposed at the vicinity of the USB ports 24 as an example of the I/O ports 16. Lighting the USB port allocation display 34 by each OS enables identifying the usable I/O ports 16. That is, controlling display of LEDs of the USB port allocation displays 34 by a hyper visor 38 that controls port allocation for an OS enables identifying which OS each port is allocated for. When, for example, there are few kinds of OSs booted by virtualization in this lightning of the USB port allocation displays 34, two colors of LEDs are used, and it is defined that an OS 1 is displayed by a green LED and an OS 2 is displayed by a red LED. Thereby the usable I/O ports 16 may be identified visually. Video port allocation displays 36 that display allocation of the video ports 26 may be structured as well.

In addition, when the number of operated OSs is large, as depicted in FIG. 7, seven-segment LEDs may be used for the USB port allocation displays 34, for example, and a number, an alphabet and so on that are defined for each of corresponding OSs in advance may be displayed.

By such structure, I/O ports that are allocated for each OS and correspond therewith can be recognized visually.

### Third Embodiment

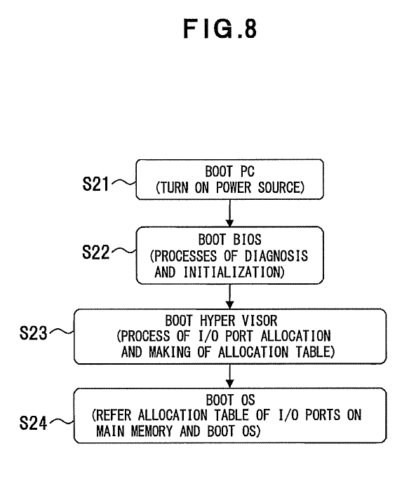

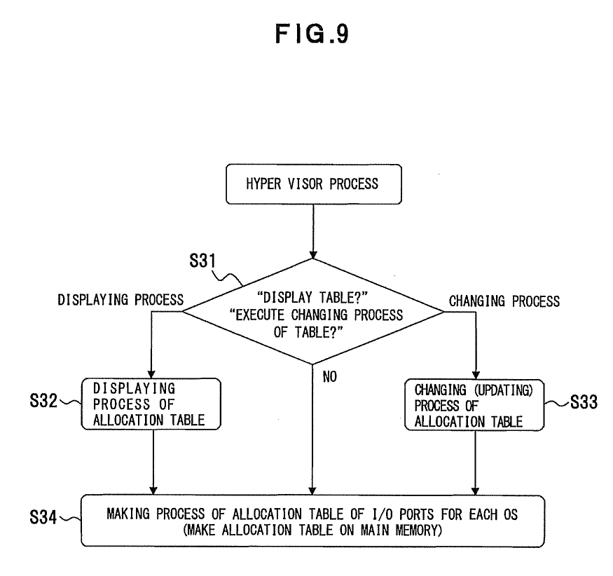

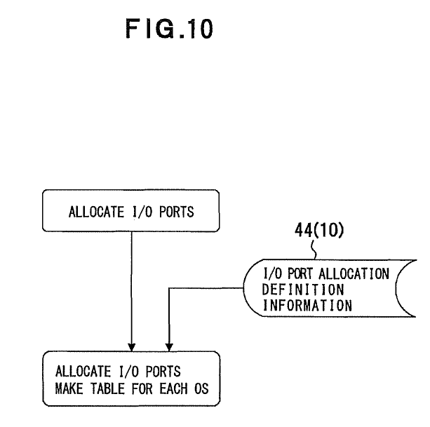

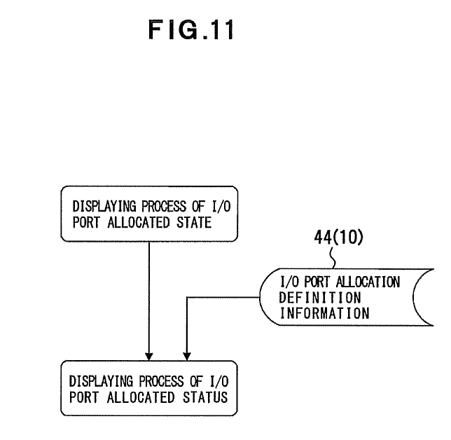

A third embodiment will be described with referring to FIGS. 8, 9, 10 and 11. FIG. 8 is a flowchart depicting a booting process of a virtualized information processor, FIG. 9 is a flowchart depicting a table making process by a hyper visor, FIG. 10 is a flowchart depicting an allocation process of I/O ports and FIG. 11 is a flowchart depicting an allocation displaying process of I/O ports. In FIGS. 8, 9, 10 and 11, description about the same components as those in FIG. 3 or 4 is omitted. Structure depicted in FIGS. 8, 9, 10 and 11 is one example, and the structure is not limited to FIGS. 8, 9, 10 and 11.

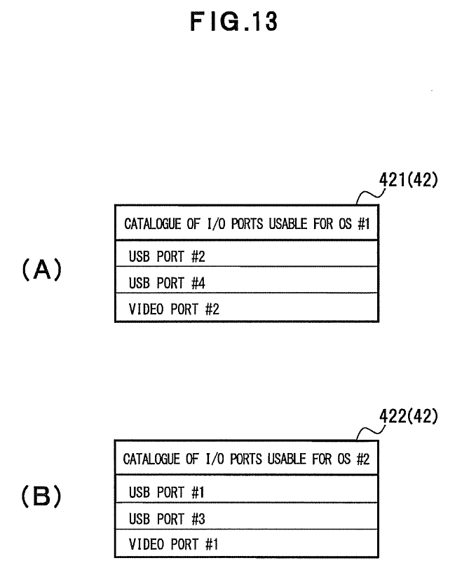

In this embodiment, the case will be described that about allocation of the I/O ports 16, the hyper visor 38 makes a □ allocation table 42 (421 and 422: FIG. 13), and on the basis of the allocation table 42, an allocation process and display of an allocated state are performed.

First, after the PC 2 is booted by turning on a power source (step S21), a BIOS in the hard disc 10 is booted (step S22) to execute processes such as diagnosis and initialization of the PC 2. After the BIOS is booted, the hyper visor 38 is booted (step S23). After creating the allocation table 42 of the I/O ports 16 and performing an allocation process, etc. step moves to boot of an OS (step S24). With referring to the allocation table 42 of the I/O ports 16 set on a main memory 8, each OS and I/O port 16 are connected.

A making process of the allocation table 42 of the I/O ports 16 that the hyper visor 38 performs at step S23 in FIG. 8 will be described with referring to FIG. 9.

After the hyper visor 38 is booted, it is determined whether the made allocation table 42 is displayed or a process of changing (updating) the allocation table 42 is performed (step S31). In this determination, when the allocation table 42 is displayed (a displaying process in step S31), step moves to a process of displaying the allocation table 42 (step S32) In this displaying process, while new making allocation table 42 is displayed on a display means (part) connected to the video port 26, the allocation table 42 stored in the main memory 8 may be displayed on the display means.

If the process of changing (updating) the allocation table 42 is performed (the changing process in step S31), step moves to the process of changing (updating) the allocation table 42 (step S33). In this changing (updating) process, for example, instead of the currently set allocation table 42, the process is executed that another allocation table 42 is read out.

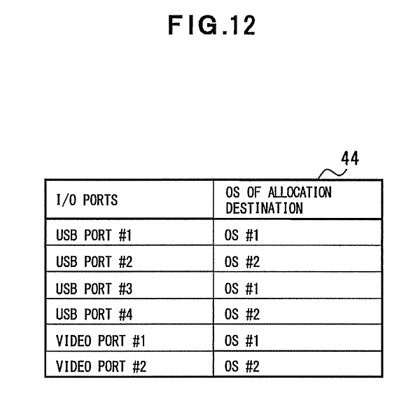

After the above displaying process (step S32) or the changing (updating) process (step S33) is executed, or, if any of the displaying process or the changing process is not executed in step S31 (NO of step S31), step moves to a making process of the allocation table 42 of the I/O ports 16 for each OS (step S34). In this process, for example, as depicted in FIG. 10, the allocation table 42 is made on the main memory 8 based on I/O port allocation definition information 44 (FIG. 12). Then, this allocation table 42 is delivered to each of booting OSs as allocation information (step S24 in FIG. 8).

In a hyper visor process depicted in FIG. 9, concerning the displaying process (step S32) and the changing (updating) process (step S33) of the allocation table 42, either the displaying process or the changing (updating) process is performed (step S31). This embodiment is not limited to the above structure. Both of the changing process and the displaying process may be performed together. For example, when the changing (updating) process is performed, the allocation tables 42 before and after changing may be respectively displayed on a display means, or, changing of both allocation tables 42 may be displayed for comparison.

A displaying process of an allocated state of the I/O ports 16 is, as depicted in FIG. 11, executed based on the I/O port allocation definition information 44 (FIG. 12) stored in the hard disc 10, etc. that are storing means (part).

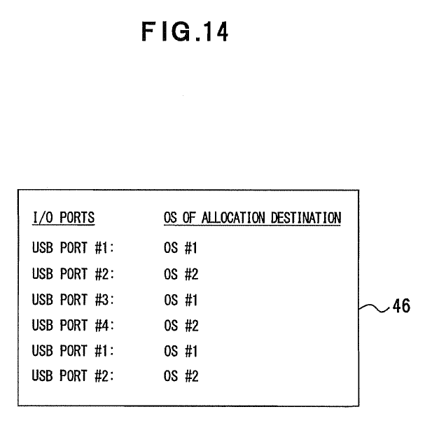

Setting information concerning allocation of I/O ports will be described with referring to FIGS. 12, 13A, 13B and 14. FIG. 12 depicts one example of I/O port allocation definition information, FIGS. 13A and 13B depict one example of made allocation tables and FIG. 14 depicts one example of a display screen of an allocation displayed on a display means. Structure of FIGS. 12, 13A, 13 B and 14 is one example, and the structure is not limited to FIGS. 12, 13A, 13B and 14.

In storing means (part) such as the hard disc 10, as described above, stored is the allocation definition information 44 that is used for creating the allocation table 42 of the I/O ports 16 allocated for each OS during boot (FIG. 10) and the displaying process of an allocated status of the I/O ports 16 (FIG. 11). This allocation definition information 44 lists, for example, as depicted in FIG. 12, types and identification numbers, etc. of the I/O ports 16 provided for the PC 2 and an OS that is an allocation destination of each I/O port 16 is related to each I/O port 16 and defined in advance. For example, FIG. 12 depicts the case that the exemplified PC 2 includes four USB ports 24 and two video ports 26. When two OSs are booting, an OS #1 is related to a USB port #1, an OS #2 is related to a USB port #2, the OS #1 is related again to a USB port #3 and the OS #2 is related to a USB port #4 to define allocation. Also, the OS #1 is related to a video port #1 and the OS #2 is related to a video port #2.

In this allocation definition information 44, the I/O ports 16 are related according to the number of OSs booting on the virtualized PC 2, that is, according to the number of virtual information processors. For example, concerning the cases that the number of booting OSs is three and four, the PC 2 has definition information for each case. According to the number of OSs that are booted, definition information may be exchanged.

In the hyper visor 38, the allocation definition information 44 of the I/O ports 16 according to the number of OSs during boot is read in (FIG. 10). Based on this allocation definition information 44, the allocation table 42 of the I/O ports 16 usable for each OS is created on the main memory 8. One example of allocation tables made by each OS is given in FIGS. 13A and 13B. FIG. 13A is an allocation table 421 representing a catalogue of I/O ports usable for the OS #1 and FIG. 13B is an allocation table 422 representing a catalogue of I/O ports usable for the OS #2.

Based on the allocation table 42 (421 and 422), each I/O port 16 and each OS are related. As depicted in FIG. 14, a display screen 46 that represents information about the I/O ports 16 and an OS of an allocation destination of the I/O ports 16, etc. may be displayed on a display means such as a monitor of the PC 2. Thereby, a user of the PC 2 can identify input/output ports (the I/O ports 16) usable for an OS during boot.

### Fourth Embodiment

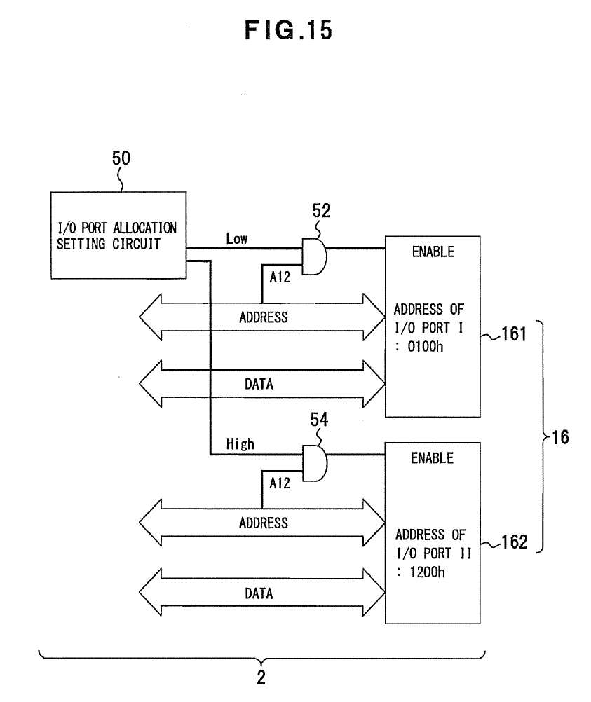

A fourth embodiment will now refer to FIG. 15. FIG. 15 is a block diagram depicting an I/O port circuit. In FIG. 15, the same components as those in FIG. 1 or 2 are denoted by the same reference numerals, and description thereof is omitted. Structure depicted in FIG. 15 is one example, and the structure is not limited to FIG. 15.

In this embodiment, for example, the PC 2 providing I/O ports 161 and 162 as I/O ports I and II respectively will be exemplified and described when processes of allocation and relating of the I/O ports 16 for and to each OS that configures a virtual information processor are executed by hardware. In this case, as depicted in FIG. 15, for each OS during boot, an I/O port allocation setting circuit 50 that performs allocation of the I/O ports 16 is provided. This I/O port allocation setting circuit 50 may be, for example, composed of the USB control circuit 20 or the video control circuit 18 depicted in FIG. 1.

For each of the I/O ports 161 and 162 sides, for example, AND circuits 52 and 54 are provided as means for switching an access from each OS between acceptance and rejection. To input sides of these AND circuits 52 and 54, an input signal from the I/O port allocation setting circuit 50 and an I/O address signal from each OS are inputted.

From the above, for example, any one of a signal “High” that permits connection and a signal “Low” that rejects connection is inputted as an input signal from the I/O port allocation setting circuit 50. In each of the AND circuits 52 and 54, an address of each of the I/O ports 161 and 162 that is disposed at each of the AND circuits 52 and 54 sides is set. Each of the AND circuits 52 and 54 receives a “High (permission)” signal sent from the I/O port allocation setting circuit 50. If an I/O address inputted from an OS side that is accessed corresponds with a set I/O address, connection to the I/O port 161 or 162 is permitted. If a “Low (rejection)” signal is received, or an I/O address of an input signal does not correspond with a set I/O address, connection to the I/O port 161 or 162 is not permitted. In this case, permission or rejection of connection to an I/O port is performed by shifting connection with an I/O port by switching.

In such structure, when OSs that are booted are two, an OS #1 and an OS #2, for example, it is defined that a range of an I/O address that the OS #1 can use is from 0000h to 0FFFh and a range of an I/O address that the OS #2 can use is from 1000h to 1FFFh. The I/O port 161 is set as a port dedicated to the OS #1, and the I/O port 162 is set as a port dedicated to the OS #2.

A process in the case of accessing from the OS #2 to the I/O port 162 will be described with referring to FIG. 15. Since the I/O port 162 is allocated for the OS #2, the I/O port allocation setting circuit 50 outputs a “Low” signal to the AND circuit 52 and an access to the I/O port 161 side is rejected. To the AND circuit 54 side, a signal “High” is outputted and an access to the I/O port 162 side is permitted. At the same time, the AND circuits 52 and 54 read out an address signal from the OS #2. In this case, for example, to an address signal from the OS #2, a signal “A12” is outputted as a part of an address (:1200h) set in the I/O port 162. In the AND circuit 52 that reads out this signal, since the signal does not correspond with a set I/O address and a signal “Low” is received from the I/O port allocation setting circuit 50, an access from the OS #2 is rejected. In the AND circuit 54, since the signal corresponds with a set I/O address and a signal “High” is received, an access from the OS #2 is permitted.

Concerning an allocation setting of I/O ports, as described in the above, based on the allocation table 42 made by the hyper visor 38 for each OS, according to an OS that accesses to each of the I/O ports 161 and 162, a signal “High” or “Low” may be outputted to the AND circuits 52 and 54. As depicted in FIG. 10, based on the I/O port allocation definition information 44, the I/O port allocation setting circuit 50 may have the allocation table 42.

As described above, when allocation of the I/O ports 16 for an access from each OS is performed, based on I/O port allocation display control, identification information of an OS allocated to the I/O port allocation display means 32 that is composed of an LED, etc. is also displayed

By such structure, switching the I/O ports 16 by a logical circuit can reduce the amount of a programming process by the hyper visor 38 before booting each OS in a virtualized information processor. For an access to the I/O ports 16 from each OS, allocation with switching by hardware enables an allocation process with a simple structure without need that an I/O port itself in an enabled state is made into disabling. Displaying this allocation information on a display means provided for each I/O port enables a user of the PC 2 to recognize usable I/O ports visually.

### Other Embodiments

(1) In the above embodiments, based on a control signal from the I/O port allocation setting circuit 50, switching of a logic circuit including the AND circuits 52 and 54 sends a Low signal in response to an access from an unallocated OS. Thereby, unallocated OS is not permitted to access, and the I/O port 16 side is maintained in an enabled state. The embodiments are not limited to the above. For example, in response to an access from an allocated OS, the I/O port 16 may be still maintained in an enabled state. If an access is from an unallocated OS, the I/O port 16 may be disabled. According to such structure, the above objects can be achieved, and, a shift by switching brings no need of a complex process by the hyper visor 38.

(2) In the above embodiments, the PC 2 is exemplified as a virtualized information processor. The embodiments are not limited to the above. For example, a virtualized information processor may be a server apparatus that a plurality of PCs are connected to, and so on.

(3) In the above embodiments, a plurality of OSs booted by virtualization, the OS 1, the OS 2 and the OS 3 (FIG. 2) may be the same, and new and old OSs may be used together in addition to the case of using many OSs of different types and functions. According to such structure, the above objects can be achieved, too. For example, changing color or display of the I/O port allocation display means 32 by each of new and old OSs enables connection with a corresponding external device.

(4) In the above embodiments, for example, the USB port 24 and the video port 26 are exemplified as input/output ports (the I/O ports 16). The embodiments are not limited to the above. For example, I/O ports may be various types of I/O ports such as a port of an IEEE (Institute of Electrical and Electronics Engineers) standard.

(5) In the above embodiments, an allocation process of each I/O port for a plurality of OSs booting in a virtualized information processor is executed when a system boots. The embodiments are not limited to the above. For example, when the number of OSs that boot during boot of a system is changed, on the occasion of this changing, allocation of I/O ports may be reconfigured. Or, many numbers of the allocation tables 42 may be made, when the number of booting OSs during boot of a system is different, to be stocked in a storing unit. Or, in accordance with changing of the number of booting OSs, the allocation table 42 may be recreated.

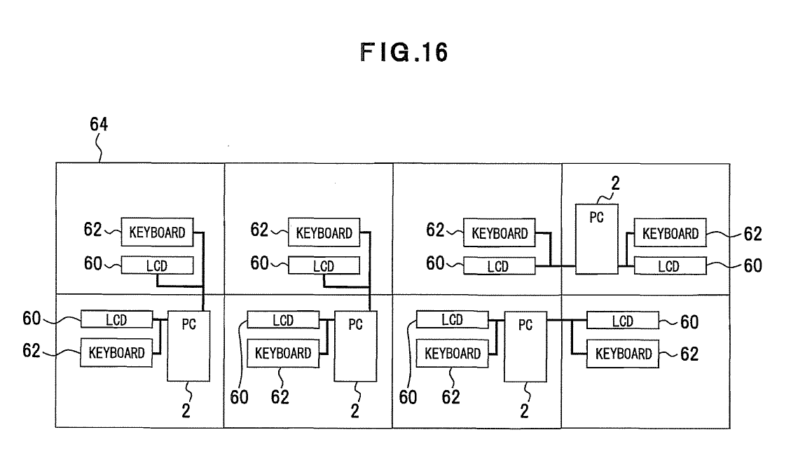

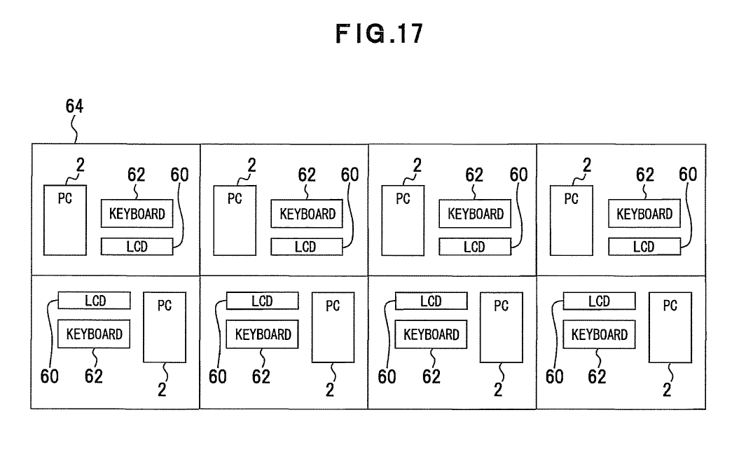

An example of an information processor providing an allocation identification apparatus of input/output ports will now be described with reference to FIGS. 16 and 17. FIG. 16 depicts a structural example of disposing PCs that share I/O ports by virtualization and FIG. 17 depicts a conventional example of structure of disposing PCs in an office, etc as a compared example. In FIG. 16, the same components as those in FIGS. 1, 5, 6 and 7 are denoted by the same reference numerals, and description thereof is omitted. Structure depicted in FIG. 16 is one example, and the structure is not limited to FIG. 16.

As disposed structure of the PC 2, for example, one LCD (Liquid Crystal Display) 60 that is a display is connected to a body of one PC 2, and a keyboard 62 that is an input apparatus and a mouse, etc. are connected thereto one by one to construct one information processor. Then this information processor can be exploited. Concerning such structure of the PC 2, for example, in an office, etc., as depicted in FIG. 17, the PC 2 of the above structure is disposed on each desk 64 and occupies the desk 64. On a set of the desks 64, a certain number of the PC 2 is disposed together.

On the contrary, concerning the PC 2 that includes the I/O ports 16 providing a plurality of the above described USB ports 24 and video ports 26 and where a plurality of OSs can be booted by virtualization, as depicted in FIG. 16, a plurality of the LCDs 60 and the keyboards 62, etc. can be connected to one PC 2, thus a plurality of virtual information processors can be configured. In this case, concerning each I/O port 16 where the LCD 60 or the keyboard 62, etc. are connected, as the above embodiments, the I/O port allocation display means 32 as depicted in FIG. 6 or 7 can be used for the I/O ports 16 allocated for each OS by the hyper visor 38 (FIG. 2). As depicted in FIG. 14, the display screen 46 that gives allocation information may be displayed on the LCD 60.

By such structure, even if one information processor is virtualized to be used as a plurality of information processors, the usable I/O ports 16 can be easily distinguished by displaying identification information about an OS related to the I/O ports 16 allocated for each OS during boot. When the PC 2, etc. are shared for facilitating saving a space or reducing power consumption, the erroneous operation can be prevented that an external device is accidentally attached or detached to or from the I/O port 16 that is allocated for another OS, etc. As concrete effects about the PC 2 displaying allocation, for example, about the PC 2 that is used in an office or a classroom in a school, a plurality of users adjacent to a body of one PC 2 can share the PC 2 easily by connecting displays, keyboards and mice, etc. Thereby, the number of the introducing PCs 2 can be greatly reduced to facilitate reduction of power consumption.

The following effects can be obtained according to the embodiments of the present invention.

(1) Expressing OSs corresponding to each of allocated input/output ports can facilitate confirmation of connectable input/output ports.

(2) Expressing OSs corresponding to each of allocated input/output ports prevents erroneous operation such that someone accidentally takes off connection of an input/output port during use.

(3) Making a hyper visor that allocating input/output ports instruct display to each input/output port can allocate ports and display allocation thereof in more simple structure.

(4) In an information processor that composes a virtualized system in which a plurality of OSs can be booted by virtualization, allocation of input/output ports with an external apparatus for each OS and expressing operable input/output ports facilitate sharing of one information processor with a plurality of persons.

While the most preferred embodiments of the present invention have been described hereinabove, the present invention is not limited to the above embodiments, and it is a matter of course that various variations and modifications can be made by those skilled in the art within the scope of the claims without departing from the spirit of the invention disclosed herein, and needless to say, such variations and modifications are also encompassed in the scope of the present invention.

The embodiments of the present invention relate to allocation of input/output ports in an information processor that composes a virtualized system operated as two or more virtual information processors and to identification thereof. A display function representing which virtual information processor controls is provided for each input/output port. Thereby, usable (controllable) input/output ports are clarified and a high convenient virtualized system can be provided. Thus, the present invention is usable.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An allocation identification apparatus of input/output ports of an information processor that is operated as two or more virtual information processors, the allocation identification apparatus comprising:
input/output ports that are allocated to the virtual information processors;
an identification information generating part that identifies the virtual information processors to which the input/output ports of the information processor are allocated, and that generates identification information thereof; and
a display part that displays the identification information generated by the identification information generating part.

2. The allocation identification apparatus of the input/output ports of claim 1, wherein
the identification information generating part is composed of a hyper visor.

3. The allocation identification apparatus of input/output ports of claim 1, wherein
the identification information generating part allocates the input/output ports provided for the information processor to a plurality of the virtual information processors based on allocation definition information.

4. The allocation identification apparatus of input/output ports of claim 2, wherein
the identification information generating part allocates the input/output ports provided for the information processor to a plurality of the virtual information processors based on allocation definition information.

5. The allocation identification apparatus of input/output ports of claim 1, wherein
the virtual information processors are a plurality of operating systems and/or applications that boot on the information processor by virtualization.

6. The allocation identification apparatus of input/output ports of claim 1, wherein the display part is composed of a light emitting diode.

7. The allocation identification apparatus of input/output ports of claim 1, wherein the input/output ports are universal serial bus ports and/or video ports.

8. An allocation identification method of input/output ports of an information processor that is operated as two or more virtual information processors, the method comprising:
allocating input/output ports to the virtual information processors;
identifying the virtual information processors to which the input/output ports of the information processor are allocated, and generating identification information thereof; and
displaying the generated identification information.

9. The allocation identification method of input/output ports of claim 8, wherein
generating the identification information of the virtual information processors is performed by a hyper visor.

10. The allocation identification method of input/output ports of claim 8, the method comprising
allocating the input/output ports provided for the information processor to a plurality of the virtual information processors based on allocation definition information.

11. The allocation identification method of input/output ports of claim 9, the method comprising
allocating the input/output ports provided for the information processor to a plurality of the virtual information processors based on allocation definition information.

12. The allocation identification method of input/output ports of claim 8, the method comprising:
making a table that allocates each of the input/output ports to the virtual information processors; and
allocating each of the input/output ports to the virtual information processors based on the table.

13. The allocation identification method of input/output ports of claim 9, the method comprising:
making a table that allocates each of the input/output ports to the virtual information processors; and
allocating each of the input/output ports to the virtual information processors based on the table.

14. An information processor that is operated as two or more virtual information processors, comprising:
a plurality of input/output ports;
an allocation part that allocates the input/output ports to the virtual information processors;
an identification information generating part that identifies the virtual information processors to which the input/output ports of the information processor are allocated, and that generates identification information thereof; and
a display part that displays the identification information generated by the identification information generating part.

15. The information processor of claim 14, wherein
the identification information generating part is composed of a hyper visor.

16. The information processor of claim 14, wherein
the identification information generating part makes a table that determines the virtual information processor to which the input/output ports are allocated.

17. The information processor of claim 15, wherein
the identification information generating part makes a table that determines the virtual information processor to which the input/output ports are allocated.

18. The information processor of claim 14, comprising a storing part that stores the identification information of the virtual information processors.

19. The information processor of claim 14, comprising:
a storing part that stores allocation definition information allocating the input/output ports to the virtual information processors, wherein
the identification information generating part allocates the input/output ports provided for the information processor to a plurality of the virtual information processors based on the allocation definition information.

20. The information processor of claim 14, wherein
the virtual information processors are operating systems and/or applications two or more of which boot simultaneously by virtualization.
